(19) United States
(12) Patent Application Publication
(10) Pub. No.: US 2008/0210735 A1
(43) Pub. Date: Sep. 4, 2008

(54) POWERED STAPLING DEVICE

(76) Inventor: Lawrence D. Stratton, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/681,018

(22) Filed: Mar. 1, 2007

(51) Int. Cl. B25C 5/02

(52) U.S. Cl. 227/131

(57) ABSTRACT

The present invention relates to an powered stapling device and, more specifically, but not limited to, a powered stapling device for driving staples over a strip of linear material, such as a cable located in an otherwise inaccessible or difficult to reach place. The stapling device includes an actuation mechanism, a handle, a staple ejection mechanism, and a drive arm operable along a primary axis of the stapling device. The actuation mechanism provides energy to the drive arm, which in turn engages the staple ejection mechanism, which in turn drives the staple. At least a portion of the staple engagement mechanism may be positioned at an angle with respect to the primary axis. This configuration of the staple engagement mechanism allows the stapling device to drive the staple at an angle relative to the linear object being stapled, even when the primary axis of stapling device is aligned substantially parallel or substantially perpendicular to the linear object being stapled.

### FIELD OF THE INVENTION

This invention relates generally to a powered stapling device and, more specifically, to a powered stapling device for stapling objects that are in difficult to reach places.

### BACKGROUND OF THE INVENTION

Powered staple guns serve a variety of purposes and often the structural configuration and operation of the staple gun is customized for a specific purpose. For example, long handled staple guns are used for stapling material on ceilings. Another type of staple gun typically used in construction includes operates as a modular powered tool with an interchangeable handle and magazine units that can drive either nails or staples.

One type of powered staple gun having a long nose for reaching otherwise inaccessible locations is described in U.S. Pat. No. 3,834,602 to Obergfell (the '602 patent). The '602 patent discloses a powered staple gun with a nosepiece or drive track of substantially increased length that does not require an increased stroke for driving the nail or staple. The powered staple gun is capable of being operated by a pneumatic motor. The staple or nail driven by the powered staple gun of the '602 patent is advanced through a drive track in increments by a series of strokes, which provide the energy for driving the staple or nail. The configuration of the powered staple gun is such that the user must hold the gun substantially perpendicular with respect to a substrate onto which an object is to be stapled. For example, if the user is stapling a linear object, such as cable or wire, the user must hold the gun at a 90 degree angle to the substrate, which results in the staples being driven over the linear object such that the body of the staple is substantially perpendicular to the linear object.

It would be desirable to have a powered stapling device that can be used to reach inaccessible or difficult to reach places. In addition, it would be desirable to have a powered stapling device that can drive staple at a desired angle even though the powered stapling device is aligned with or perpendicular to a linear object that is to be stapled.

### SUMMARY OF THE INVENTION

The present invention relates to an powered stapling device and, more specifically, but not limited to, a powered stapling device for driving staples over a strip of linear material, such as a cable located in an otherwise inaccessible or difficult to reach place.

In accordance with an aspect of the invention, a stapling device includes an actuation mechanism, a handle, a staple ejection mechanism, and a drive arm operable along a primary axis of the stapling device. The actuation mechanism provides energy to the drive arm, which in turn engages the staple ejection mechanism, which in turn drives the staple. At least a portion of the staple engagement mechanism may be positioned at an angle with respect to the primary axis. This configuration of the staple engagement mechanism allows the stapling device to drive the staple at an angle relative to the linear object being stapled, even when the primary axis of stapling device is aligned substantially parallel or substantially perpendicular to the linear object being stapled.

### BRIEF DESCRIPTION OF THE DRAWINGS

Preferred and alternative embodiments of the present invention are described in detail below with reference to the following drawings:

FIG. 1 is a side, elevational view of a powered stapling device being extended into a confined space according to an embodiment of the present invention;

FIG. 2 is a top, plan view of material stapled into a substrate with angled staples supplied by the powered stapling device of FIG. 1; and

FIG. 3 is a perspective, schematic view of a powered stapling device according to an embodiment of the present invention.

### DETAILED DESCRIPTION OF THE PREFERRED EMBODIMENT

As will be described in further detail below, at least one embodiment of the invention is a powered stapling device for driving staples into a substrate to secure a strip of linear material, such as a strip of cable located in an otherwise inaccessible or difficult to reach place. For example, the powered stapling device may advantageously be used to drive angled staples into a substrate to secure ROMEX® nonmetallic sheathed cable or insulated electrical wire thereto. The orientation of the staples relative to a primary axis of the stapling device permits the staples to be driven into the substrate at an angle with respect to a linear path of the cable. ROMEX® nonmetallic sheathed cable or insulated electrical wire is a brand of cable/wire made by General Cable Industries, Inc. and is commonly installed in buildings in the space defined by a roof-to-ceiling joist intersection.

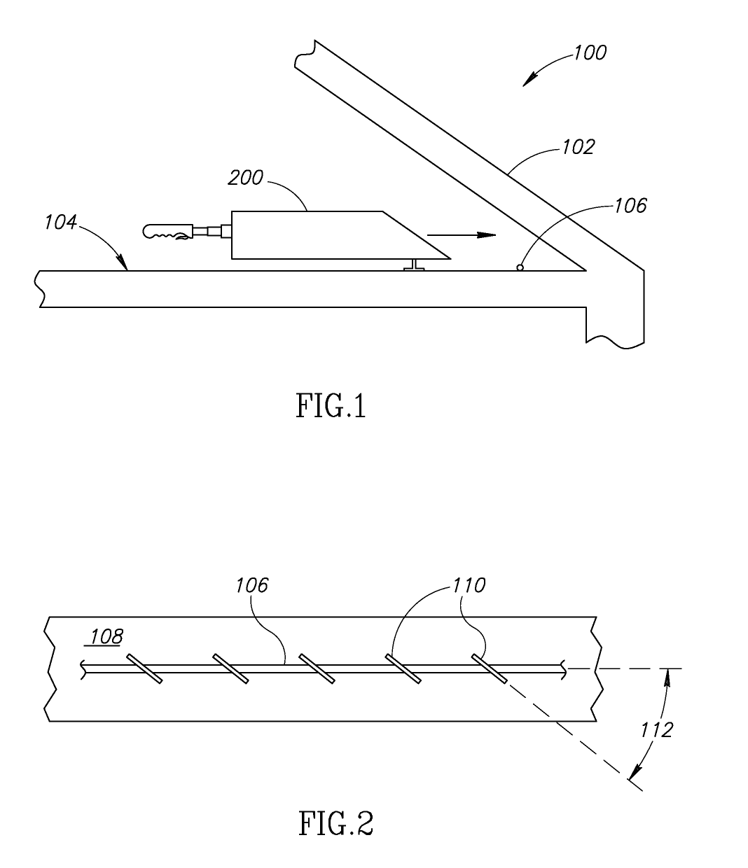

FIG. 1 shows a building 100 having a roof portion 102 and a ceiling portion 104 with a strip of cable 106 ready to be secured to the ceiling portion 104. A stapling device 200, according to an embodiment of the present invention, is extendable to drive staples onto the cable 106 to secure the cable to the ceiling portion 104.

FIG. 2 shows a linear strip of material 106 installed on a substrate 108 with staples 110. The staples 110 are driven into the substrate 108 at an angle 112, where the angle 112 is measured with respect to the path of the linear strip of material 106 according to the illustrated embodiment. The arrangement of the stapling device 200, as will be described below, permits the staples 110 to be driven into the substrate 108 at the angle 112 even when the stapling device 200 is parallel or perpendicular to the path of the linear strip material 106. The term staples, as used herein, may include, but is not limited to straight, angled, insulated, metallic, and non-metallic staples.

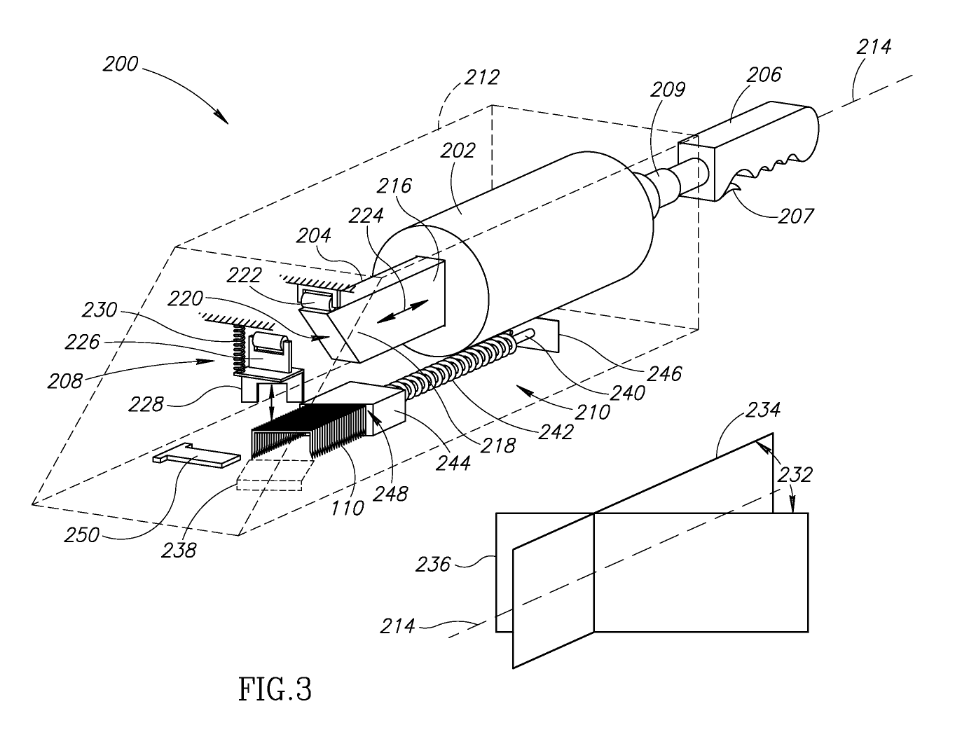

FIG. 3 shows the stapling device 200 according to an illustrated embodiment of the invention. For clarity and brevity, the structural and operational components of the stapling device 200 are shown schematically. In the illustrated embodiment, the stapling device 200 includes an actuation mechanism 202, a drive arm 204, a handle 206 having a trigger 207, a staple engagement mechanism 208, and a staple feeding assembly 210. These components are located in a housing 212, which is shown in dashed lines in the illustrated embodiment.

The actuation mechanism 202 may be any mechanism capable of repeatedly moving the drive arm 204 into and out of engagement with the staple engagement mechanism 208. In one embodiment, the actuation mechanism 202 is a pneumatic assembly powered by a compressed air source (not shown). In another embodiment, the actuation mechanism 202 is a hydraulic assembly powered by a pressurized hydraulic fluid. In yet another embodiment, the actuation mechanism 202 is solenoid unit powered by an electrical source (not shown). The electrical source may be a battery, an AC power source, CO₂ cartridge, propane cartridge, or some equivalent power source. The actuation mechanism 202 may be coupled to the handle 206 with a telescoping rod 209 according to one embodiment. The telescoping rod 209 permits the user to extend a reach of the stapling device 200 to reach into difficult or confined spaces. Alternatively, the actuation mechanism 202 may be coupled to the handle 206 in a fixed manner.

In the illustrated embodiment, the drive arm 204 takes the form of an elongated arm operable along a primary axis 214. The drive arm 204 includes a first end 216 coupled to the actuation mechanism and a second end 218 having a surface or face 220 engageable with the staple ejection mechanism 208. The surface 220 is angled relative to the primary axis 214 such that contact with the staple ejection mechanism 208 urges the staple ejection mechanism 208 downward to eject the staple 110. In addition, a roller or bearing 222 may be located above the drive arm 204 to maintain a linear motion 224 of the drive arm 204 during actuation. The roller or bearing 222 may also operate to provide a reaction load path into the housing 212 as the drive arm 204 drives the staple 110 into the substrate 108 (FIG. 2). The roller or bearing 222 may be fixed relative to the housing 212 or may include a damping or shock absorbing mechanism (not shown), which in combination with the mass of the powered stapling device 200, helps to absorb at least some of the energy generated when the staple 110 is driven into the substrate 108.

The staple ejection mechanism 208 includes a first engagement portion 226 and a staple engagement portion 228. The first engagement portion 226 and the staple engagement portion 228 may be integrally formed as a one-piece unit or may be separate structural components that cooperate with one another. A biasing member 230, such as a tension spring, may be located between a portion of the housing 212 and the staple engagement portion 228 and operates to pull the staple ejection mechanism 208 back to a neutral, non-stapling position when the drive arm 204 moves out of engagement with the first engagement portion 226.

In the illustrated embodiment, the staple engagement portion 228 is configured to engage a top portion of a single staple 110 and is angled relative to the primary axis 214 a staple engagement angle 232. For purposes of this description, the staple engagement angle 232, is defined as the angle 232 between a first plane 234 and a second plane 236, where the first plane 234 is oriented parallel to the primary axis 214 and the second plane 236 intersects the first plane 234 to define the staple engagement angle 232. Preferably, the staple engagement angle 232 is in a range of about 30-60 degrees. In one embodiment, the staple engagement angle 232 is 45 degrees. The staple engagement angle 232 may be larger or smaller than the aforementioned ranges, but it is appreciated that the staple engagement angle 232 is not parallel or perpendicular to the primary axis 214. Accordingly, the powered stapling device 200, when oriented parallel or perpendicular to the path of the linear strip of material 106 (FIG. 2), will install staples 110 at the angle 112 (FIG. 2). In this operational example, the angle 112 and the staple engagement angle 232 are equivalent.

In one embodiment, the powered stapling device 200 further includes a guide member 238 extending from the housing 212. The guide member 238 provides the user with an approximate location of where the staple 110 will be driven. The guide member 238 may be moveable relative to the housing 212 so it does not interfere with the stapling process. For example, the guide member 238 may be extended and viewable by the user, but is permitted to retract back into the housing 212 as the staple 110 is installed into the substrate 108 (FIG. 2). The guide member 238 advantageously allows the user to accurately orient the powered stapling device 200.

The staples 110 are loaded and moved into ejection position by the staple feeding assembly 210. The staple feeding assembly 210 includes a loading rod 240, a biasing member 242, a push guide 244, and an access tab 246. The staple feeding assembly 210 is generally configured and operates like a conventional staple feeding assembly found in staple guns and office staplers with the exception of the configuration of the push guide 244. The push guide 244 includes an angled face 248 for engaging the angled staples 110. The angled face 248 coincides with the staple engagement angle 232 described above. In one embodiment, the push guide 244 may be removable and replaceable with a push guide having a different angled face 248. The push guide 244 may be fastened or otherwise attached to the loading rod 240.

In addition to the aforementioned aspects of the powered stapling device 200, a locking mechanism 250 may be engageable with the staple ejection mechanism 208, the actuation mechanism 202, or the drive arm 204 to disable or prevent stapling. In the illustrated, the locking mechanism 250 is a contact safety lock engageable with the staple ejection mechanism 208. The user manually engages and disengage the contact safety lock allow or prevent the stapling device 200 from operating. In other embodiments, the locking mechanism 250 may take the form of a keyed interlock switch, a solenoid-latching interlock, a limit switch, or some other equivalent device.

By way of example, the operation of the stapling device 200 includes the user positioning the stapling device 200 over the linear object 106 (FIG. 2). The linear object 106, for example a run of ROMEX® cable, is positioned proximate to a stapling surface or substrate 108 (FIG. 2). As described above, drive arm 204 is oriented along the primary axis 214 of the stapling device 200 such that the primary axis 214 is approximately either perpendicular or parallel to the linear object 106 when the stapling device 200 is placed in position for stapling. Once in position, the user activates the trigger 207, which is in communication with the actuation mechanism 202. The actuation mechanism 202 thereby provides the necessary energy to the drive arm 204 to urge the drive arm 204 into engagement with the staple ejection mechanism 208. This engagement drives the staple 110 over the linear object 106 and thus staples the linear object 106 to the substrate 108. Further, the staple ejection mechanism 208 drives the staple 110 over the linear object 106 at an angle, which is the staple engagement angle 232. Accordingly, the staple 110 is driven over the linear object 106 such that the staple 110 is not aligned parallel with the linear object 106 and is not perpendicular to the linear object 106. Thus in one embodiment, the staple ejection mechanism 208 driving the staple 110 over the linear object 106 results in the staple 110 being driven at the angle 232, which is in a range of about 30-60 degrees relative to the primary axis 214 of the stapling device 200. In another embodiment, the staple 110 is driven at the angle 232, which is about 45 degrees relative to the primary axis 214.

To extend the reach of the stapling device 200, the user may extend the telescoping 209 located generally between the handle 206 and the actuation mechanism 202. The telescoping rod 209 permits the user to extend a reach of the stapling device 200 to reach into difficult or confined spaces or alternatively to bring the stapling end of the device in closer proximity of the user for increased stability during stapling.

In addition, the stapling action of the stapling device 200 may include providing energy to the drive arm 204 such that the drive arm is repeatedly urged into engagement with the staple ejection mechanism 208. For example, the actuation mechanism 202 may be configured to move the drive arm 204 such that the drive arm 204 provides a series of low impact engagements with the staple ejection mechanism 208. The series of engagements may occur rapidly when the trigger 207 is activated. Advantageously, the series of low impact engagements may allow the user to better control and stabilize the stapling device 200, and in particular when the stapling device 200 is in an extended position.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined by reference to the claims that follow.

1. A stapling device comprising:
an actuation mechanism wherein an actuation movement of the actuation mechanism is along a primary axis;
a handle coupled to the actuation mechanism generally along the primary axis; and
a staple ejection mechanism configured to receive the actuation movement and responsive to the actuation movement to drive a staple out of the stapling device radially away from the primary axis.

2. The stapling device of claim 1, further comprising a trigger located proximate a portion of the handle and in operable communication with the actuation mechanism.

3. The stapling device of claim 1, wherein the staple is driven radially away from the primary axis, the staple being further oriented at a staple angle to the primary axis, the staple angle being neither parallel nor perpendicular to the primary axis angle relative to the primary axis.

4. The stapling device of claim 1, further comprising a telescoping mechanism located between the handle and the actuation mechanism for moving the handle relative to the actuation mechanism.

5. The stapling device of claim 1, further comprising:
a plurality of staples, the plurality being arranged along a staple axis substantially parallel to the primary axis;
a biasing member arranged to urge the plurality of staples into a position where each staple, in succession, is drivable by the staple ejection mechanism;
a push member coupled to the biasing member, the push member having a contact face being oriented substantially at a staple angle to the staple axis, the contact face being in contact with one of the plurality of staples when the plurality of staples are loaded in the stapling device.

6. The stapling device of claim 3, wherein the staple angle is selected to be in a range of about 30 to 60 degrees.

7. The stapling device of claim 3, wherein the staple angle is approximately 45 degrees.

8. The stapling device of claim 1, wherein the actuation mechanism is powered pneumatically by a compressed air source.

9. The stapling device of claim 1, further comprising a guide component located near the staple ejection mechanism, the guide component indicative of an approximate location where a staple will be driven, and the guide component viewable by an operator of the stapling device so the operator is able to accurately orient the stapling device when driving staples.

10. A stapling device comprising:
staple engagement means for driving a staple in a first plane;
actuation means for selectively moving along a primary axis and for causing the staple engagement means to drive the staple out of the stapling device radially away from the primary axis;
wherein the staple is oriented substantially within the first plane as the staple is driven, the first plane intersecting the primary axis at a staple angle.

11. The stapling device of claim 10, wherein at least a portion of the staple engagement means is oriented for driving movement parallel to the first plane.

12. The stapling device of claim 10, wherein the staple angle is an angle between about 30 and 60 degrees.

13. The stapling device of claim 10, wherein the actuation means for is actuated responsive to manipulating a trigger coupled to a handle, wherein the handle is coupled to and extends from the actuation means.

14. The stapling device of claim 10, wherein the staple engagement means translates actuator movement along the primary axis to driving staples radially from the primary axis by movement of a ramp.

15. The stapling device of claim 14, wherein the ramp engages a roller to drive the staple.

16. A method of stapling comprising:
positioning a stapling device over a linear object, the linear object positioned proximate to a stapling surface, the stapling device having an actuation mechanism oriented for actuating movement along a primary axis of the stapling device such that the primary axis is approximately either perpendicular or parallel to the linear object when the stapling device in a position for stapling;
activating a trigger in communication with the actuation mechanism of the stapling device and thereby providing energy to a staple ejection mechanism for driving a staple radially outward from the primary axis over the linear object and stapling the linear object to the stapling surface.

17. The method of claim 16, wherein the staple ejection mechanism driving the staple over the linear object results in the staple being driven at a staple angle in a range of about 30-60 degrees relative to the primary axis of the stapling device.

18. The method of claim 16, wherein the staple ejection mechanism driving the staple over the linear object results in the staple being driven at the angle of about 45 degrees relative to the primary axis of the stapling device.

19. The method of claim 16, further comprising extending a telescoping member located between a handle and the actuation mechanism of the stapling device to extend a reach of the stapling device.

20. The method of claim 16, wherein the staple ejection mechanism includes a ramp engaging a roller to translate movement along the primary axis to movement radially from the primary axis to drive the staple when the trigger is activated.

21. A stapling device comprising:
staple engagement means for driving a staple, the staple being oriented in a first plane and being one of a plurality of staples the plurality of staples oriented parallel to the first plane and ordered along a primary axis;
actuation means for selectively causing the staple engagement means to drive the staple;
wherein the first plane intersecting the primary axis at a staple angle.

22. The stapling device of claim 21 wherein the staple angle is an angle between about 30 and 60 degrees.

23. The stapling device of claim 22, wherein the staple angle is 45 degrees.
